(19) United States
(12) Patent Application Publication
(10) Pub. No.: US 2003/0113562 A1
(43) Pub. Date: Jun. 19, 2003

(54) Biaxially oriented polyester film with good metal adhesion, its use, and process for its production

(76) Inventors: Stefan Bartsch, Wiesbaden (DE); Herbert Peiffer, Mainz (DE); Richard Lee Davis, Wiesbaden (DE)

Correspondence Address: ProPat, L.L.C., 2912 Crosby Road, Charlotte, NC, 28211-2851, US

(21) Appl. No.: 10/230,721

(22) Filed: Aug. 29, 2002

(30) Foreign Application Priority Data
Sep. 8, 2001 (DE) 101 44 123.1

(51) Int. Cl. B32B 27/06

(52) U.S. Cl. 428/480; 428/500

(57) ABSTRACT

The invention relates to a coextruded, biaxially oriented polyester film with high metal adhesion, composed of a base layer B and of at least one outer layer A applied to the base layer. The invention further relates to the use of the film and to a process for its production.

The invention relates to a coextruded, biaxially oriented polyester film with high metal adhesion, composed of a base layer B and of at least one outer layer A applied to the base layer. The invention further relates to the use of the film and to a process for its production.

### BACKGROUND OF THE INVENTION

EP A 0 144 878 describes films with a copolyester coating based on isophthalic acid, aliphatic dicarboxylic acid, and sulfoisophthalic acid, which do indeed have good adhesion to metals. However, this metal adhesion is unsatisfactory for certain applications.

EP A 0 035 835 describes a polyester film which comprises a sealable outer layer based on isophthalate units. Due to the high thickness of this layer, ≧2 μm, cracks form in the metal layer after metalization and reduce barrier effectiveness, and are therefore unacceptable.

EP A 0 878 297 describes a transparent biaxially oriented polyester film with a base layer B which is composed of at least 80% by weight of a thermoplastic polyester, and with at least one outer layer A which is composed of a mixture of polymers which comprises at least 40% by weight of ethylene 2,6-naphthalate units and up to 40% by weight of ethylene terephthalate units, and/or up to 60% by weight of units of cycloaliphatic or aromatic diols and/or dicarboxylic acids.

In a film of example 11 of EP A 0 878 297, the outer layer A comprises 60% by weight of ethylene 2,6-naphthalate units. In order to achieve the desired oxygen transmission, the thickness of the outer layer A has to be raised to 3 μm. After metalization, a film of this type has surface cracks, which are unacceptable. Furthermore, a film of this type is uneconomic due to high capital expenditure and high material costs.

It was an object of the present invention to provide a biaxially oriented polyester film with high metal adhesion which does not have the disadvantages of the prior art films mentioned and which moreover is economic to produce, and has good processability with no deterioration, or an improvement, in optical properties.

### BRIEF DESCRIPTION OF THE INVENTION

The invention provides a coextruded, biaxially oriented polyester film with good metal adhesion, where the polyester film has at least one base layer B and at least one outer layer A in the presence or absence of other conventional additives, wherein the outer layer A

a) comprises a copolymer having from 20 to 80% by weight of ethylene 2,6-naphthalate units and up to 80% by weight of ethylene terephthalate units in the presence or absence of units made from cycloaliphatic or aromatic diols and dicarboxylic acids,

b) has thickness ≦1.0 μm, and

c) has metal adhesion (after metalization) of ≧2 N/25 mm.

The invention further relates to the use of this film and to a process for its production.

### DETAILED DESCRIPTION OF THE INVENTION

The outer layer A preferably comprises from 25 to 75% by weight, in particular from 30 to 70% by weight, of the units mentioned of ethylene 2,6-naphthalate.

The film of the invention has improved metal adhesion, without any occurrence of cracks in the metal layer of the metalized film. In addition, the processability of the film extends to high-speed processing machinery. During production of the film it has also been ensured that regrind can be reintroduced to the extrusion process at a concentration of up to 60% by weight, based on the total weight of the film, without any significant resultant adverse effect on the physical properties of the film.

The film of the invention has at least two layers, specifically the base layer B and the metal-bonding outer layer A. It preferably has three layers and then encompasses another outer layer C, which may be identical with or different from the metal-bonding outer layer A.

The base layer B of the film is generally composed of a thermoplastic polyester, preferably of at least 90% by weight of the polyester. Suitable polyesters are those made from ethylene glycol and terephthalic acid (=polyethylene terephthalate, PET), of ethylene glycol and naphthalene-2,6-dicarboxylic acid (=polyethylene-2,6-naphthalate, PEN), from 1,4-bishydroxymethylcyclohexane and terephthalic acid (=poly(1,4-cyclo-hexanedimethylene terephthalate), PCDT), or else from ethylene glycol, naphthalene-2,6-dicarboxylic acid and biphenyl-4,4′-dicarboxylic acid (=polyethylene-2,6-naphthalatebibenzoate, PENBB), or from mixtures of these. Preference is given to polyesters composed of at least 90 mol %, in particular at least 95 mol %, of PET and/or PEN. The remaining monomer units derive from other aliphatic, cycloaliphatic, or aromatic diols and, respectively, dicarboxylic acids which may also be used in the layer A (or the layer C).

Examples of other suitable aliphatic diols are diethylene glycol, triethylene glycol, aliphatic glycols of the general formula HO—(CH₂)ₙ—OH, where n is an integer from 3 to 6 (in particular 1,3-propanediol, 1,4-butanediol, 1,5-pentanediol, and 1,6-hexanediol) and branched aliphatic glycols having up to 6 carbon atoms. Among the cycloaliphatic diols, mention may be made of cyclohexane diols (in particular 1,4-cyclohexanediol).

Examples of suitable other diols which are aromatic have the formula HO—C₆H₄—X—C₆H₄—OH, where X is —CH₂—, —C(CH₃)₂—, —C(CF₃)₂—, —O—, —S—, and —SO₂—. Bisphenols of the formula HO—C₆H₄—C₆H₄—OH are also very suitable.

Examples of other aromatic dicarboxylic acids are benzene dicarboxylic acids, naphthalene dicarboxylic acids (such as naphthalene-1,4- or -1,6-dicarboxylic acid), biphenyl-x,x′-dicarboxylic acids (such as biphenyl-4,4′-dicarboxylic acid), diphenylacetylene-x,x′-dicarboxylic acids (such as diphenylacetylene-4,4′-dicarboxylic acid), and stilbene-x,x′-dicarboxylic acids. Among the cycloaliphatic dicarboxylic acids, mention may be made of cyclohexane dicarboxylic acids (e.g. cyclohexane-1,4-dicarboxylic acid). Among the aliphatic dicarboxylic acids, the (C₃-C₁₉) alkanediacids are particularly suitable, and the alkane moiety here may be straight-chain or branched.

One way of preparing the polyesters uses the transesterification process. Here, the starting materials are dicarboxylic esters and diols, which are reacted using the usual transesterification catalysts, such as the salts of zinc, of calcium, of lithium, of magnesium, or of manganese. The intermediates are then polycondensed in the presence of well known polycondensation catalysts, such as antimony trioxide or titanium-containing salts. Another equally good preparation process which may be used is direct esterification in the presence of polycondensation catalysts, starting directly from the dicarboxylic acids and the diols.

The outer layer A is composed of at least one copolymer or of a mixture of polymers of from 20 to 80% by weight, preferably from 25 to 75% by weight, in particular from 30 to 70% by weight, of ethylene 2,6-naphthalate units, and up to 80% by weight, preferably up to 75% by weight, and in particular up to 70% by weight, of ethylene terephthalate units, and/or of the abovementioned units of cycloaliphatic or aromatic diols and/or dicarboxylic acids.

The copolymers for the outer layer A here may be prepared by various processes:

a) In copolycondensation, terephthalic acid and naphthalene-2,6-dicarboxylic acid are placed in a reactor together with ethylene glycol, and polycondensed to give a polyester, using the customary catalysts and stabilizers. The terephthalate and naphthalate units then have random distribution in the polyester.

b) PET and PEN, in the desired ratio, are melted together and mixed, either in a reactor or preferably in a melt kneader (twin-screw kneader) or an extruder. Immediately after the melting, transesterification reactions begin between the polyesters. Initially, block copolymers are obtained, but as reaction time increases—depending on the temperature and mixing action of the agitator—the blocks become smaller, and long reaction times give a random copolymer. However, it is not necessary and indeed not always advantageous to wait until a random distribution has been achieved, since the desired properties are also obtained with a block copolymer. The resultant copolymer is then extruded from a die and granulated.

c) PET and PEN in pellet form are mixed in the desired ratio, and the mixture is sent to the extruder for the outer layer A. Here, the transesterification to give the copolymer takes place directly during production of the film. This process has the advantage of being very cost-effective, and generally gives block copolymers, the block length being dependent on the extrusion temperature, the mixing action of the extruder, and the residence time in the melt.

The outer layer A generally has a thickness of ≦1.0 μm, preferably ≦0.9 μm, in particular ≦0.8 μm. It generally makes up less than 22% by weight, preferably less than 20% by weight, of the entire film.

In principle, the polymers used for the other, non-metal-bonding outer layer C or for any intermediate layers present may be those used in the base layer B and described above. In another particular embodiment of the invention, the outer layer C uses the polymers used in the outer layer A. This then gives another metal-bonding outer layer.

The desired metal-bonding properties and the desired quality of the metal layer (no cracks) in the film of the invention are obtained by combining the properties of the copolyester used for the metal-bonding outer layer and setting a layer thickness of ≦1.0 μm, preferably ≦0.9 μm and in particular ≦0.8 μm.

The metal adhesion of ≧2 N/25 mm is achieved if the polymers described above are used for the metal-bonding outer layer A. The metal-bonding outer layer A may be modified for purposes of film handling and processability. This is best achieved with the aid of suitable antiblocking agents of selected size, added at a particular concentration to the metal-bonding layer, and specifically in such a way as firstly to minimize blocking and secondly not to give any substantial impairment of metal adhesion.

It has been found that excessive outer layer thicknesses lead to cracks in the metal layer after metalization. These cracks may be detected visually, e.g. in a light box or in the beam of light from a slide projector, and give the metalized film undesirable properties, for example reducing barrier effectiveness with respect to oxygen or water vapor.

In the preferred three-layer embodiment of the film of the invention, the two layers A and C generally also comprise conventional additives, such as stabilizers and/or antiblocking agents. They are advantageously added to the polymer or polymer mixture before melting begins. Examples of stabilizers used are phosphorus compounds, such as phosphoric acid or phosphoric esters. The base layer B may also comprise these conventional additives.

Typical antiblocking agents (also termed pigments in this context) are inorganic and/or organic compounds, such as silicon dioxide, calcium carbonate, amorphous silica, talc, magnesium carbonate, barium carbonate, calcium sulfate, barium sulfate, lithium phosphate, calcium phosphate, magnesium phosphate, aluminum oxide, LiF, the calcium, barium, zinc or manganese salts of the dicarboxylic acids used, carbon black, titanium dioxide, kaolin, or crosslinked polystyrene particles, or crosslinked acrylate particles.

The pigments selected may also be mixtures of two or more different pigments or mixtures of pigments of the same composition but of different particle size. These additives may be added in the respective advantageous concentrations to each of the layers, e.g. in the form of a glycolic dispersion during polycondensation, or preferably by way of masterbatches during extrusion.

The constituents added to the thermoplastic of the film may be fed either to the base layer or else to one or both outer layers. Extrusion is clearly suitable for this purpose, preferably with inclusion of the masterbatch process.

In masterbatch technology it is important that the particle size and the bulk density of the masterbatch are similar to those of the thermoplastic, so that uniform distribution can be achieved, and thus uniform achievement of the desired film properties.

In masterbatch technology, the additives are first dispersed in a solid carrier material. The carrier material used may be the thermoplastic itself, e.g. the polyethylene terephthalate, or else other polymers sufficiently compatible with the thermoplastic. To produce the film, the masterbatch is mixed with the thermoplastic provided as raw material for the film and these are treated together in an extruder, whereupon the constituents melt together and are thus distributed within the thermoplastic.

A preferred pigment is SiO₂ in colloidal or chain-type form. These forms are very effectively incorporated into the polymer matrix and produce only very few vacuoles. The latter generally cause haze and their occurrence should therefore be minimized. The diameter of the particles used may vary within wide limits. However, it has proven advantageous to use particles whose average primary particle diameter is less than 100 nm, preferably less than 60 nm, particularly preferably less than 50 nm, and/or particles whose average primary particle diameter is greater than 1 μm, preferably greater than 1.5 μm, particularly preferably greater than 2 μm. The diameters of these last-mentioned particles should not, however, be greater than 5 μm.

To achieve the abovementioned properties of the film of the invention, it has proven advantageous to select a pigment concentration for the base layer B which is lower than that of the two outer layers A and C. In the case of a three-layer film of the type mentioned, the pigment concentration in the base layer B will be in the range from 0 to 0.15% by weight, preferably ≦0.12% by weight, and in particular ≦0.10% by weight. The diameter of the particles used is not in principle subject to any restriction, but particular preference is given to particles with an average diameter of ≧1 μm.

To achieve the property profile mentioned for the film, the outer layers A and C may, in one embodiment, have more pigment (i.e. a higher pigment concentration) than the base layer B. The pigment concentration in these outer layers A and C is generally in the range from 0.01 to 1.0% by weight, preferably from 0.02 to 0.8% by weight, and in particular from 0.03 to 0.6% by weight, based in each case on the weight of the outer layer. The two outer layers A and C may have the same pigmentation level. It is also possible for the pigment concentration selected for the metal-bonding outer layer A to be lower than for the non-metal-bonding outer layer C, in order to improve the desired properties or further optimize processing performance. In one particularly advantageous version, it is also possible for there to be no pigment in the outer layer A. It is advantageous to use an ABC layer structure for a three-layer film.

Between the base layer and the outer layers, there may, where appropriate, also be an intermediate layer. This may again be composed of the polymers described for the base layer, preferably of the polyester used for the base layer. It may also comprise the conventional additives mentioned. The thickness of the intermediate layer is generally ≧0.3 μm, and is preferably in the range from 0.5 to 15 μm, in particular from 1.0 to 10 μm, and very particularly from 1.0 to 5 μm.

In the particularly advantageous three-layer embodiment of the film, the thickness of the outer layer A is ≦1.0 μm, preferably in the range from 0.1 to 0.9 μm, in particular from 0.1 to 0.8 μm. The thickness of the outer layer C is generally ≧0.1 μm, and is in the range from 0.2 to 4.0 μm, preferably from 0.2 to 3.5 μm, in particular from 0.3 to 3 μm, and very particularly from 0.3 to 2.5 μm, and the thicknesses of the outer layers A and C here may be identical or different.

The total thickness of the polyester film of the invention may vary within certain limits. It is from 3 to 80 μm, preferably from 4 to 50 μm, in particular from 5 to 30 μm, the proportion made up by the layer B generally being from 5 to 95% of the total thickness.

In the process for producing the films of the invention, the best method is to feed the polymers for the base layer B and the two outer layers A and C to three extruders. Any foreign bodies or contamination present may be filtered out from the polymer melt prior to the extrusion process. The melts are then extruded through a coextrusion die by known coextrusion processes to give flat melt films and laminated to one another. The multilayer film is then drawn off and solidified with the aid of a chill roll and, where appropriate, other rollers. The film is then biaxially stretched (oriented), and the biaxially stretched film is heat-set and, where appropriate, corona- or flame-treated on the surface intended for treatment.

The biaxial orientation process is generally carried out sequentially. For this, it is preferable first to orient longitudinally (i.e. in machine direction,=MD) and then transversely (i.e. perpendicular to the machine direction,=TD). This causes orientation of the molecular chains. The longitudinal orientation process may be carried out with the aid of two or more rollers running at different speeds corresponding to the desired stretching ratio. For the transverse orientation process, use is generally made of an appropriate tenter frame. However, the biaxial orientation process may also be carried out simultaneously in the two directions in a specific tenter frame.

The temperature at which the orientation process is carried out may vary over a relatively wide range, and depends on the desired properties of the film. The longitudinal stretching is generally carried out at from 80 to 130° C., and the transverse stretching at from 90 to 150° C. The longitudinal stretching ratio is generally in the range from 2.5:1 to 6:1,preferably from 3:1 to 5.5:1. The transverse stretching ratio is generally in the range 3.0:1 to 5.0:1, preferably from 3.5:1 to 4.5:1. Prior to the transverse stretching, one or both surfaces of the film may be coated in-line by known coating processes. The in-line coating may serve, for example, to improve the adhesion of any printing ink applied, or else to improve antistatic performance or processing performance.

In the heat-setting which follows, the film is held for from 0.1 to 10 seconds at a temperature of from 150 to 250° C. The film is then wound up in a usual manner.

To achieve other desired properties, the film may also be coated in a known manner. Typical coatings are layers with release action, antistatic action, slip-improving action, anti-deposition action (moisture), or other layers with adhesion-promoting action. Clearly, these additional layers may be applied to the film by way of in-line coating, using aqueous dispersions, prior to the transverse stretching step.

The film of the invention has excellent suitability for use in flexible packaging, and specifically wherever excellent metal adhesion is a key factor. Examples of these applications are those known as “bag-in-box” packaging, in which use is made of a multilayer composite made from metalized PET and polyethylene film laminated to its two sides.

Table 1 below shows the properties of the outer layer A:

TABLE 1

| | General | | | | |
|---|---|---|---|---|---|
| OUTER LAYER A | range | Preferably | In particular | Unit | Test method |
| PEN-PET copolymer content | 80:20-20:80 | 75:25-25:75 | 70:30-30:70 | % by weight | |
| Metal adhesion | >2 | >2.5 | >3 | N/25 mm | internal |
| Thickness of outer layer | ≦1 | ≦0.9 | ≦0.8 | μm | |

The following standards and methods were used to test each of the properties:

SV (standard viscosity)

Standard viscosity SV (DCA) was measured by a method based on DIN 53726 in dichloroacetic acid.

Intrinsic viscosity (IV) is calculated as follows from standard viscosity:

IV(DCA)=6.67·10⁻⁴SV(DCA)+0.118.

Metal Adhesion

Metal adhesion was determined using an internal specification: prior to adhesive bonding, the metalized specimen of film (300 mm in length*180 mm across) of the present invention was placed on a smooth piece of card (200 mm in length*180 mm across, about 400 g/m2, bleached, outer laps coated). The overlapping margins of the film were folded back onto the reverse side and secured with adhesive tape.

For the adhesive-bonding of the film of the invention, use is made of a standard polyester film of 12 μm thickness (e.g. Melinex 800) and of a doctor device and doctor bar No. 3 from Erichsen, first applying about 1.5 ml of adhesive (Novacote NC 275+CA 12; mixing ratio: 4/1+7 parts of ethyl acetate) to the metalized side of the film (=outer layer A). After aerating to remove the solvent, the standard polyester film was laminated to outer layer A using a metal roller DIN EN 20 535 (width 200 mm, diameter 90 mm, weight 10 kg). The lamination parameters are:

| | |
|---|---|
| Amount of adhesive: | 5 +/− 1 g/m² |
| Aeration after adhesive application: | 4 min +/− 15 s |
| Doctor thickness (Erichsen): | 3 |
| Doctor speed level: | about 133 mm/s |
| Bond curing time: | 2 h at 70° C. in a circulating air |
| | drying cabinet |

A 25+/−1 mm strip cutter is used to take specimens of about 100 mm length. About 50 mm of composite is needed here, and 50 mm of unbonded separate laps for securing/clamping the test specimen. Double-sided adhesive tape is used to secure the entire reverse side of the metalized film of the invention (base layer B or outer layer C) to a sheet metal substrate. The sheet with the composite adhesive-bonded thereto was clamped into the lower clamping jaw of the tensile test machine, the clamp separation being 100 mm. The unlaminated end of the standard polyester film was clamped into the upper clamping jaw of the tensile test machine (Zwick) so that the resultant peel angle was 180°.

| | | |
|---|---|---|
| Specimen width: | 25 | mm |
| Pretensioning force: | 0.1 | N |
| Test length: | 25 | mm |
| Separation rate until pretensioning force applied: | 25 | mm/min |
| Start position: | 5 | mm |
| Test displacement: | 40 | mm |
| Sensitivity: | 0.01 | N |
| Separation velocity: | 100 | mm/min |

The peel force test result is equivalent to the minimum adhesive force between the metal layer and the film of the invention, since the adhesive force between the adhesive and the standard film is markedly greater.

The data given, rounded to one decimal point, are the average peel force in N/25 mm needed to separate the composite when the separation velocity is 100 mm/min.

Cracking (Internal Test Method)

Cracks were detected by an internal method: a specimen of a metalized film of width 1.0 m and length of 0.5 m was placed on a light box. The defects detectable visually (cracks) were counted.

### EXAMPLES

The examples below and the comparative examples used multilayer, biaxially oriented ABC films (exception: comparative example 2: AB film), and these were produced by known coextrusion processes on an extrusion line. The total film thickness was in each case 12 μm, except for example 7 (23 μm) and comparative example 2 (15 μm). The outer layer A in examples 1 to 7 (production as in example 1) and comparative example 1 was composed of 100% by weight of a copolyester of ethylene terephthalate units and ethylene naphthalate units in varying molar ratios. In the base layer B use was made of 100% by weight of a polyethylene terephthalate (RT 49 from the company Kosa). The outer layer C was composed of 88% by weight of PET (RT 49 from Kosa) and 12% by weight of a masterbatch made from 97.75% by weight of RT 49 from Kosa and 1.0% by weight of ®Sylobloc 44 H (synthetic SiO₂ from Grace) and 1.25% by weight of Aerosil TT 600 (chain-type SiO₂ from Degussa). Example 1 of EP-A 0 035 835 was repeated as comparative example 2 (AB film structure).

### Examples 1 to 7 and Comparative Example 1

Chips made from polyethylene terephthalate (prepared via the transesterification process using Mn as transesterification catalyst, Mn concentration: 100 ppm) were dried at 150° C. to a residual moisture level below 100 ppm and sent to the extruder for the base layer B. Chips made from polyethylene terephthalate and PET chips comprising the pigment mixture were likewise passed into the extruder for the non-metal-bonding outer layer C.

Chips made from polyethylene terephthalate and polyethylene-2,6-naphthalate were dried in various mixing ratios at 160° C. to a moisture level below 100 ppm and sent directly to the extruder for producing the outer layer A, and extruded at about 300° C. The melt was filtered and extruded through a coextrusion die to give a flat film, and laminated onto the base layer as outer layer A. The multilayer film was discharged by way of the die lip and solidified on a chill roll. The residence time for the two polymers for the outer layer A through the extrusion process was about 5 min. This gave a copolymer under the stated conditions.

Coextrusion, followed by stepwise longitudinal and transverse orientation, was used to produce a transparent three-layer film with ABC structure.

Table 2 gives the film structure and the properties achieved in each of the examples.

The production conditions for each of the steps in the process were:

| Extrusion: | | | |
|---|---|---|---|
| Temperatures | Layer A: | 3e+08° | C. |
| | Layer B: | ° | C. |
| | Layer C: | ° | C. |
| Take-off roll temperature | | 30° | C. |
| Longitudinal stretching: | | | |
| Temperature: | | 80-120° | C. |
| Longitudinal stretching ratio: | | 4.4 | |
| Transverse stretching: | | | |
| Temperature: | | 80-136° | C. |
| Transverse stretching ratio | | 4.4 | |
| Setting: | | | |
| Temperature: | | 230° | C. |
| Duration: | | 3 | s |

### Comparative Example 2

Example 1 of EP-A-0 035 835 was repeated. Polyethylene terephthalate (RT 49 from Kosa) was used in the base layer B, and a polymer having 82 mol % of ethylene terephthalate and 18 mol % of ethylene isophthalate was used in the outer layer A. SiO₂ with an average diameter of 1 μm was introduced into the outer layer at a concentration of 0.25% by weight, based on the weight of the outer layer. The outer layer had a thickness of 2.25 μm and the total film thickness was 15 μm. At the light box, 12 cracks could be detected in the metal layer after metalization.

TABLE 2

| | | Layer thickness | | | | | Behavior in |
|---|---|---|---|---|---|---|---|
| | Outer layer A | μm | | | Metal adhesion | | metal-adhesion |
| Example | mol %* | A | B | C | N/25 mm | Cracks | test |
| E 1 | 80:20 | 0.7 | 9.8 | 1.5 | 2 | 0 | full-surface |
| | | | | | | | separation |
| E 2 | 20:80 | 0.7 | 9.8 | 1.5 | 2.1 | 0 | full-surface |
| | | | | | | | separation |
| E 3 | 70:30 | 0.7 | 9.8 | 1.5 | 2.8 | 0 | full-surface |
| | | | | | | | separation |
| E 4 | 30:70 | 0.7 | 9.8 | 1.5 | 2.7 | 0 | full-surface |
| | | | | | | | separation |
| E 5 | 50:50 | 0.7 | 9.8 | 1.5 | 3 | 0 | full-surface |
| | | | | | | | separation |
| E 6 | 80:20 | 0.9 | 9.6 | 1.5 | 2.9 | 0 | full-surface |
| | | | | | | | separation |
| E 7 | 80:20 | 0.7 | 20.8 | 1.5 | 3 | 0 | full-surface |
| | | | | | | | separation |
| CE 1 | 80:20 | 1.1 | 9.4 | 1.5 | 3.0 | 10 | film breaks |
| | | | | | (cracking) | | during test |
| CE 2 | 82:18** | 2.25 | 12.25 | — | 6.4 | 12 | full-surface |
| | | | | | (cracking) | | separation |

*ethylene terephthalate:ethylene naphthalate ratio
**ethylene terephthalate:ethylene isophthalate ratio, example 1 EP-A-0 035 835 repeated

1. A biaxially oriented polyester film with good metal adhesion, where the polyester film has at least one base layer B and at least one outer layer A in the presence or absence of other conventional additives, wherein the outer layer A
a) comprises a copolymer having from 20 to 80% by weight of ethylene 2,6-naphthalate units and up to 80% by weight of ethylene terephthalate units in the presence or absence of units made from cycloaliphatic or aromatic diols and dicarboxylic acids, other than 2,6-naphthalate dicarboxylic acid or terephthalic acid
b) has thickness ≦1.0 μm, and
c) has metal adhesion (after metalization) of ≧2 N/25 mm.

2. The polyester film as claimed in claim 1, wherein the outer layer A comprises from 25 to 75% by weight, of ethylene 2,6-naphthalate units, and up to 75% by weight, of ethylene terephthalate units.

3. The polyester film as claimed in claim 1 wherein the thickness of the outer layer A is ≦0.9 μm.

4. The polyester film as claimed in claim 1, wherein the film has another outer layer C on that side of the base layer B which is opposite to the outer layer A.

5. A process for producing a biaxially oriented polyester film with good metal adhesion as claimed in claim 1, which comprises coextruding, through a flat-film die, the melts corresponding to the individual layers of the film, to give a flat melt film, drawing off the resultant film on one or more rollers for solidification, then stretching (orienting) the film biaxially, and then heat-setting the biaxially stretched film, and finally cooling and winding-up the film.

6. The process as claimed in claim 5, wherein the polymer for the outer layer A comprises a copolymer having from 20 to 80% by weight of ethylene 2,6-naphthalate units and up to 80% by weight of ethylene terephthalate units in the presence or absence of units made from cycloaliphatic or aromatic diols and dicarboxylic acids other than 2,6-naphthalate dicarboxylic acid as terephthalic acid.

7. The process as claimed in claim 5, wherein a regrind is used at a concentration of up to 60% by weight, based on the total weight of the film.

8. A method of making a flexible packaging which comprises transforming a film as claimed in claim 1 into flexible packaging.

9. The method as claimed in claim 8, wherein the flexible packaging is a “bag-in-box” packaging.
